(19) United States
(12) Patent Application Publication
(10) Pub. No.: US 2008/0026629 A1
(43) Pub. Date: Jan. 31, 2008

(54) Electrical connector

(75) Inventors: Lu Zhao, ShenZhen (CN); Yao-Chi Huang, Tu-Cheng (TW); Wen He, ShenZhen (CN); Qi-Jin Yi, ShenZhen (CN); Jie-Feng Zhang, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/881,860

(22) Filed: Jul. 30, 2007

(30) Foreign Application Priority Data
Jul. 28, 2006 (CN) 200620076025.0

(51) Int. Cl. H01R 4/50

(52) U.S. Cl. 439/342

(57) ABSTRACT

An electrical connector (10) includes a base (101), and a cover (102) locatable above the base. The base has a major surface (1011) with a plurality of terminal receiving passageways (1010) extending therefrom. The cover has a major face (1025) opposite the major surface and spaced apart from the major surface of the base. A plurality of discrete protrusions (1012) is arranged extending longitudinally from one of said major face and said major surface towards the other, and positionable adjacent the passageways. Thus, a plurality of voids is located laterally adjacent the discrete protrusions and between the major surface of the base and the major face of the cover, thereby allowing the heat from pin-like conductive elements (21) of a CPU chip (20) to be dissipated through the plurality of laterally voids around the pin-like conductive elements.

### BACKGROUND OF THE INVENTION

1. Field of the Invention

The present invention relates to the art of electrical connectors, and more particularly to an electrical connector provided with a heat dissipation member for a CPU chip, which is mountable onto the electrical connector.

2. Description of the Related Art

One conventional electrical connector 80 is shown in FIGS. 3 and 4 for a CPU chip 90 to be mounted thereon. The electrical connector 80 comprises a base 801, a cover 802 slidably engaged on the base 801, and a driving member 803, in a form of a lever, received in between the cover 802 and the base 801 for driving the cover 802 to slide on the base 801. The cover 802 defines a plurality of holes 8020 in rows therein. The base 801 defines a plurality of slots 8010 adapted for receiving a plurality of terminals 8011 therein. Each of the slots 8010 corresponds to the hole 8020 of the cover 802 and remains in communication with the hole 8020. The CPU chip 90 is mounted upon the cover 802 of the electrical connector 80, with thereof a plurality of downwardly extending pin-like elements 91 for being inserted into the slots 8010 of the base 801 through the holes 8020 of the cover 802. When the cover 802 is driven to be at a tight status, the pin-like elements 91 of the CPU chip 90 is urged for electrically mating with the terminals 8011 of the base 801 so as to form a reliable electrical interconnection between the terminals 8011 and the CPU chip 90. Typically, during the operation of the CPU chip 90, a great deal of heat will be dissipated from the pin-like elements 91 of the CPU chip 90. However, a problem often occurs that the heat is not easily dissipated from the CPU chip 90. This is so because the cover 802 has a major face abuttingly engageable with a major surface of the base 801 (see FIG. 2), and thus there is no sufficient space formed around the pin-like elements 91 of the CPU chip 90. Bad dissipation will result in the un-stable operation of the CPU chip 90, which is undesirable for the user. Therefore, there is a need to provide a new electrical connector to resolve the above-mentioned shortcoming.

### SUMMARY OF THE INVENTION

An electrical connector according to an embodiment of the present invention includes a base, and a cover locatable above the base. The base has a major surface with a plurality of terminal receiving passageways extending therefrom. The cover has a major face opposite the major surface, and spaced apart from the major surface of the base. A plurality of discrete protrusions is arranged extending longitudinally from one of said major face and said major surface towards the other, and positionable adjacent the passageways. Thus, a plurality of voids is located laterally adjacent the discrete protrusions and between the major surface of the base and the major face of the cover, thereby allowing the heat from pin-like conductive elements of a CPU chip to be dissipated through the plurality of laterally voids around the pin-like conductive elements.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of an electrical connector according to an embodiment of the present invention;

FIG. 2 is a cross sectional view of a part of the assembled electrical connector of FIG. 1;

FIG. 3 is an exploded, perspective view of a conventional electrical connector; and

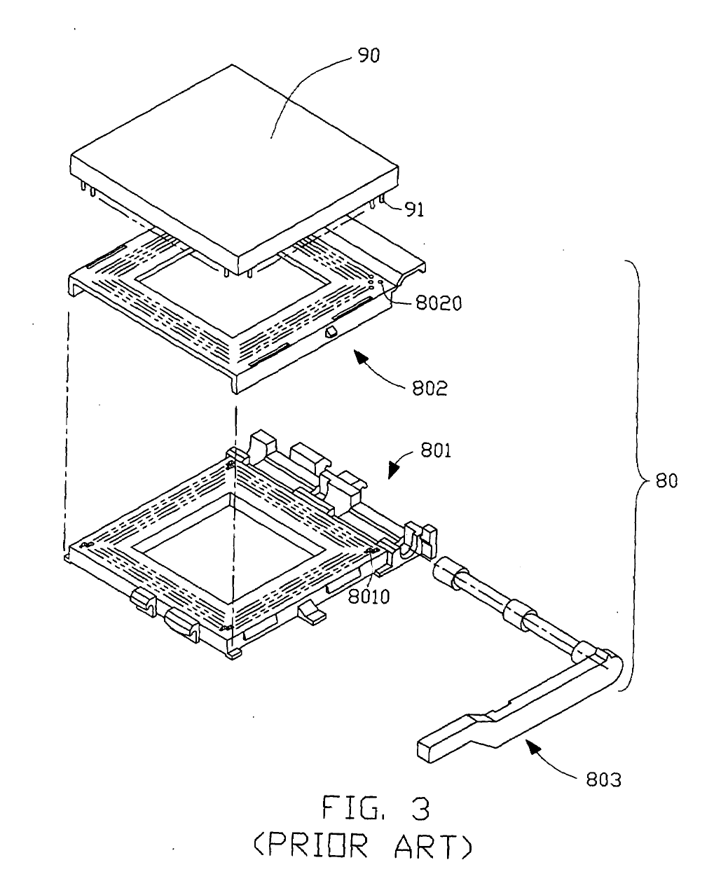

FIG. 4 is a cross sectional view of a part of the assembled electrical connector of FIG. 3.

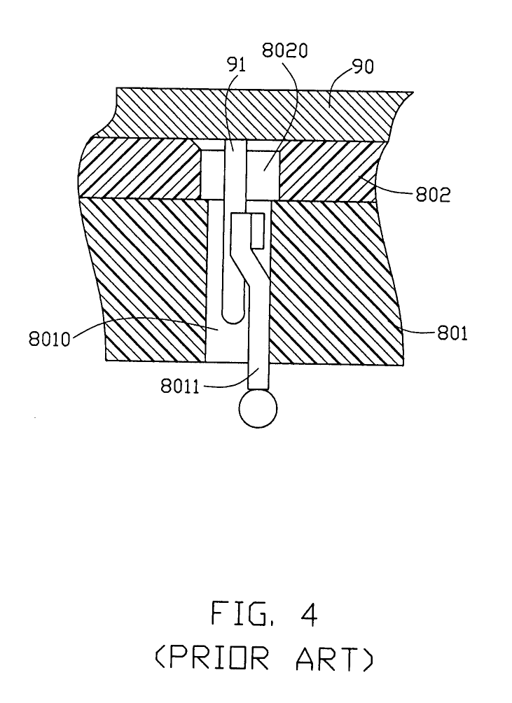

### DETAILED DESCRIPTION OF PREFERRED EMBODIMENT

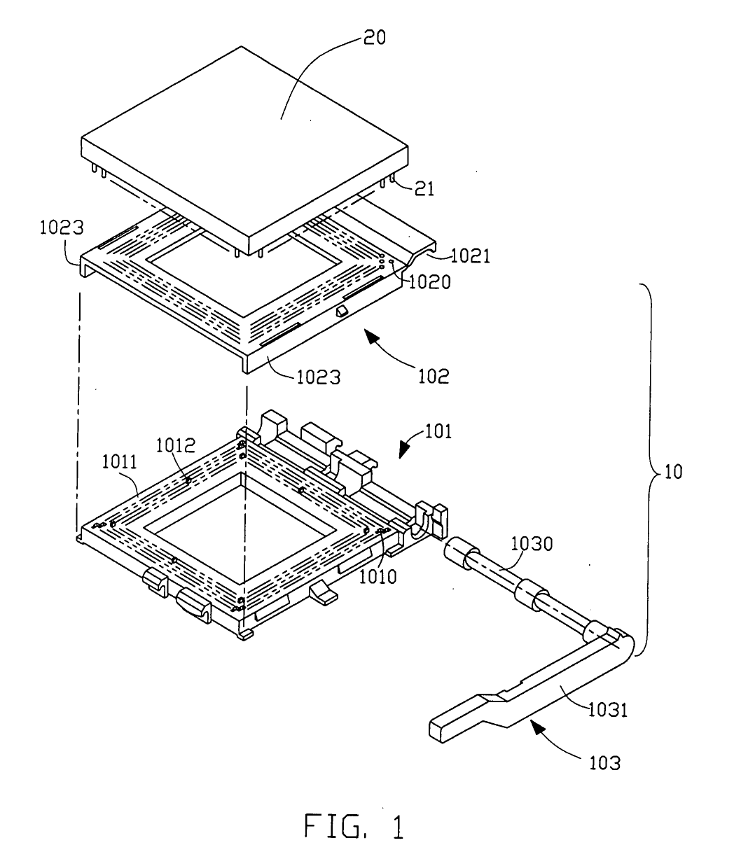

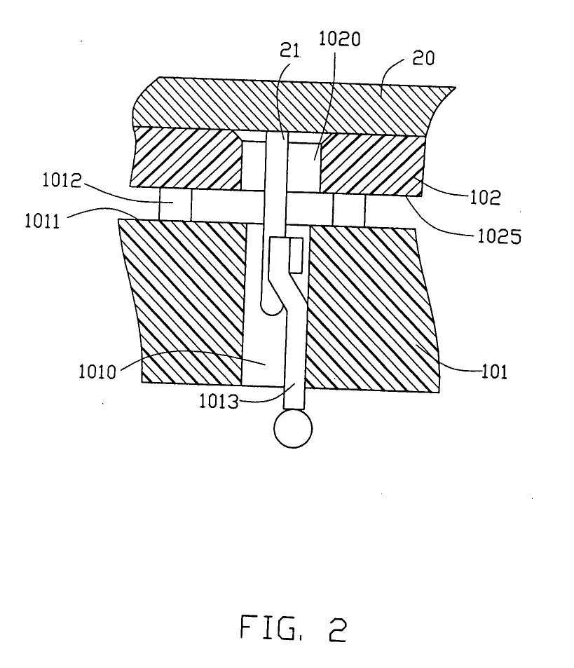

Referring to FIGS. 1 and 2, an electrical connector 10 according to the embodiment of the present invention is shown for a CPU chip 20 to be mounted thereon. The electrical connector 10 comprises a base 101, a cover 102 locatable above the base 101, and a driving member 103 received in between the cover 102 and the base 101. In this embodiment, the driving member 103 is of a lever shape, and operable to drive the cover 102 to slide on the base 101 thus changing the electrical connector 10 between a tight status and a released status. The lever-shaped driving member 103 further includes a lateral rod 1030, and a longitudinal rod 1031 attached to the lateral rod 1030 to be at a right angle with the lateral rod 1030. Actually, the lateral rod 1030 of the lever-shaped driving member 103 is received in between the cover 102 and the base 101, while the longitudinal rod 1031 is exposed out of the cover 102 and the base 101, thereby allowing the user to change the electrical connector 10 from the tight status to the released status. It should be noted that the driving member might have any suitable shapes other than the lever shape, such as a cam-like driving element.

The base 101 defines a major surface 1011 with a plurality of terminal receiving passageways 1010 extending therefrom, the passageways 1010 adapted for receiving a plurality of terminals 1013 therein. The cover 102 defines a plurality of slots 1020, each of which corresponds to a passageway 1010 of the base 101 and remains in communication with the passageway 1010. In the tight status, each pair of the passageway 1010 and the slot 1020 firmly receives a pin-like conductive element 21 of the CPU chip 20. The cover 102 has opposed side portions 1023 slidably engaged with corresponding side edges of the base 101, with a major face 1025 of the cover 102 opposite the major surface 1011 of the base 101 and spaced apart from the major surface 1011. A plurality of discrete protrusions 1012 is arranged extending longitudinally between the major surface 1011 of the base 101 and the major face 1025 of the cover 102, and positionable adjacent the passageways 1010. In this embodiment, the protrusions 1012 extend longitudinally from the major surface 1011 of the base 101 towards the major face 1025 of the cover 102. Opposed ends of each protrusion 1012 are disposed on the major surface 1011 of the base 101 and the major face 1025 of the cover 102 respectively when the cover 102 is locatable above the base 101. However, in an alternative embodiment, the protrusions 1012 integrally extend from the major face 1025 of the cover 102 toward the major surface 1011 of the base 101. As such, a plurality of voids is located laterally adjacent the discrete protrusions 1012 and between the major surface 1101 of the base 101 and the major face 1025 of the cover 102, thereby allowing the heat from the pin-like conductive elements 21 of the CPU chip 20 to be dissipated through the plurality of laterally voids around the pin-like conductive elements 21.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector comprising:
a base having a major surface with a plurality of terminal receiving passageways extending therefrom;
a cover locatable above the base, the cover having a major face opposite said major surface, the major face spaced apart from said major surface of the base;
a plurality of discrete protrusions extending longitudinally from one of said major face and said major surface towards the other, the discrete protrusions positionable adjacent the passageways;
a plurality of voids located laterally adjacent said discrete protrusions and between said major surface of the base and said major face of the cover.

2. The electrical connector of claim 1, wherein each of said protrusions has opposed ends disposed on the major surface of the base and the major face of the cover, respectively.

3. The electrical connector of claim 1, wherein the cover has opposed side portions slidably engaged on corresponding side edges of the base.

4. The electrical connector of claim 1, further comprising a driving member, the driving member having a portion received in between the cover and the base for driving the cover to slide on the base.

5. The electrical connector of claim 1, wherein the driving member is of a lever shape, the driving member having said portion, in a form of a lateral rod, received in between the cover and the base, and a longitudinal rod attached to the lateral rod and exposed out of the cover and the base.

6. An electrical connector comprising:
a base having a major surface with a plurality of terminal receiving passageways extending therefrom;
a cover locatable above the base, the cover having a major face opposite said major surface, said major face of the cover spaced apart from said major surface of the base;
a plurality of discrete protrusions extending longitudinally between said major surface and said major face and positionable adjacent the passageways;
a plurality of voids located laterally adjacent said discrete protrusions and between said major surface of the base and said major face of the cover.

7. The electrical connector of claim 6, wherein each of said protrusions extends from the major surface of the base towards the major face of the cover.

8. The electrical connector of claim 6, wherein each of said protrusions extends from the major face of the cover towards the major surface of the base.

9. The electrical connector of claim 6, wherein each of said protrusions has opposed ends disposed on the major surface of the base and the major face of the cover, respectively.

10. The electrical connector of claim 6, wherein the cover has opposed side portions slidably engaged on corresponding side edges of the base.

11. The electrical connector of claim 6, further comprising a driving member, the driving member having a portion received in between the cover and the base for driving the cover to slide on the base.

12. The electrical connector of claim 6, wherein the driving member is of a lever shape, the driving member having said portion, in a form of a lateral rod, received in between the cover and the base, and a longitudinal rod attached to the lateral rod and exposed out of the cover and the base.

13. An electrical connector assembly comprising:
an insulative base defining a plurality of vertically extending passageways;
a plurality of contacts dispose din the corresponding passageways, respectively; and
an insulative cover retained to and mounted upon the base with a plurality of apertures in vertical alignment with the corresponding passageways, respectively, and moveable relative to the base in a horizontal direction; wherein
a bottom face of the cover is spaced from an upper face of the base with a distance therebetween for heat ventilation consideration.

14. The electrical connector assemble as claimed in claim 13, wherein said gap results from a plurality of protrusions sandwiched between the bottom face and the upper face.

15. The electrical connector assembly as claimed in claim 14, wherein said protrusions are integrally formed with the upper face.

16. The electrical connector assembly as claimed in claim 14, wherein said cover defines a pair of side walls which protectively hide said protrusion in a side view.

17. The electrical connector assembly as claimed in claim 13, further including an electronic package having downwardly extending pins thereof, wherein said pins extends through the corresponding apertures, the gap and the passageways, respectively.
